(19) United States
(12) Patent Application Publication
(10) Pub. No.: US 2012/0223811 A1
(43) Pub. Date: Sep. 6, 2012

(54) Multiple Antenna Localizing

(75) Inventors: Ben J. Wild, San Francisco, CA (US); Artem Tkachenko, San Francisco, CA (US); Steve Wang, Mickelton, NJ (US); Robert Barton, San Jose, CA (US)

(73) Assignee: CHECKPOINT SYSTEMS, INC., Philadelphia, PA (US)

(21) Appl. No.: 13/039,405

(22) Filed: Mar. 3, 2011

(51) Int. Cl. H04Q 5/22

(52) U.S. Cl. 340/10.1

(57) ABSTRACT

A reader includes a single receiver circuit and a switching circuit coupled to the single receiver circuit. A first antenna connection is coupled to the switching circuit, wherein the first antenna connection is configured to receive a first signal from a source of radio frequency waves. A second antenna connection is coupled to the switching circuit and configured to receive a second signal from the source of radio frequency waves. A processor is configured to determine angle of arrival information in accordance with the first and second signals. The processor is further configured to determine relative phase information in accordance with the first and second signals. Additionally, the processor is configured to localize the source of radio frequency waves in accordance with the angle of arrival information. The switching circuit includes a multiplexer selectively coupling the first and second antenna connections to the single receiver circuit.

### BACKGROUND OF THE INVENTION

1. Field of Invention

The present invention generally relates to the field of RFID communication systems, and more particularly, to a system and method for localizing sources of radio frequency waves within RFID communication systems.

2. Description of Related Art

RFID technology has been applied in many different applications to improve business efficiencies. RFID tags are typically associated with assets, and the asset tags are read by RFID readers as they move through a supply chain. As RFID technology has improved over the years, the read range of RFID tags has increased significantly. Furthermore, it is expected that the read range of RFID tags will continue to increase in the future as the technology continues to improve. This has driven the development of new technologies that can determine the position of RFID tags with a higher degree of accuracy.

Several technologies for positioning tags are currently known in the art. For example, phased array antennas have been used to obtain the angle of arrival of tag backscatter signals from RFID tags. The angle of arrival information of the backscatter signals can be used to estimate the positioning information of the RFID tags. When phased arrays are used to obtain the angle of arrival of the tag backscatter signals in this manner the positioning information of the tags can be obtained more accurately.

However, a major disadvantage of using a phased array for obtaining the angle of arrival information in this manner in the known art is that it requires an RFID reader with multiple receiver chains, where each receiver in the RFID reader is connected to a separate antenna element in the antenna array. While this can significantly improve the accuracy of the positioning information obtained, it also significantly increases the costs of the readers since the RFID receivers can be very expensive. Furthermore, most of the RFID communication systems on the market include single receiver readers. Therefore, it would be useful to allow users of new and existing RFD) systems to obtain angle of arrival information, and thus RFID tag positions, using the lower cost single receiver RFID readers.

US. Pat. Pub. No. US2002/0190845 A1 published Dec. 19, 2002 by Moore discloses an RFID communications system for locating objects with tags in which remote sensing antennas are placed at locations to be monitored for the presence of tags. In the system taught by Moore scanning interrogators with multiplexed antenna inputs are connected to the remote sensing antennas. One antenna at a time is activated by a multiplexer, and a common detection circuit is used for detecting the proximity of RFID tags. Each RFID antenna has a known location, and when an RFID tag is read by an antenna the known location of the antenna is used to indicate a region in which the tag is located. However, the RFID communications system disclosed by Moore does not permit a determination of the tag position based on the angle of arrival information using a reader with a single receiver.

U.S. Pat. Pub. No. US2005/0273218 A1 by Breed published Dec. 8, 2005 discloses a system for obtaining information about components in a car. In the Breed system multiple antennas and multiple sensors and switches are provided for reading RFID tags located in different areas of the car. Multiplexing can be used with the antennas in the Breed system, and correlation of the signals received by the antennas can be used to isolate signals based on the direction of the signals. Additionally, the phase shifts of a SAW accelerometer are measured with a single antenna, and signals from multiple transmitting devices are spatially multiplexed to allow more than one device to communicate at the same time and frequency.

Additionally, U.S. Pat. Pub. No. US2010/0039228 A1 published Feb. 18, 2010 by Sadr discloses an RFID communication system using multiple receiver antennas to estimate RFID tag location. U.S. Pat. Pub. No. US2007/0106897 A1 published May 10, 2007 by Kulakowski discloses a system using a multiplexer to couple RFID reader circuitry to one of two antennas. WO2010/129833 A1 by Johnson discloses a system having a plurality of RFID antennas disposed in mating connectors multiplexed to an RFID transceiver.

However, none of the foregoing RFID communications systems permit users to determine angle of arrival information or positioning information using a relatively inexpensive single receiver RFID reader.

All references cited herein are incorporated herein by reference in their entireties.

### BRIEF SUMMARY OF THE INVENTION

Summary information will be provided when claims are finalized.

### BRIEF DESCRIPTION OF SEVERAL VIEWS OF THE DRAWINGS

The invention will be described in conjunction with the following drawings in which like reference numerals designate like elements and wherein:

FIG. 1 shows a schematic representation of radio frequency waves incident upon receiver antenna elements of an antenna array.

FIG. 2 shows a block diagram representation of a prior art angle of arrival measurement system for localizing a source of radio frequency waves in an RFID communication system.

FIG. 3 shows a block diagram representation of an angle of arrival measurement system for localizing a source of radio frequency waves suitable for use with the system and method of the present invention.

FIG. 4 shows a more detailed schematic representation of an angle of arrival measurement reader for localizing a source of radio frequency waves suitable for use with the system and method of the present invention.

FIG. 5 shows a flow chart representation of a preferred embodiment of the system and method of the present invention.

FIG. 6 shows a flow chart representation of an alternate preferred embodiment of the system and method of the present invention.

### DETAILED DESCRIPTION OF THE INVENTION

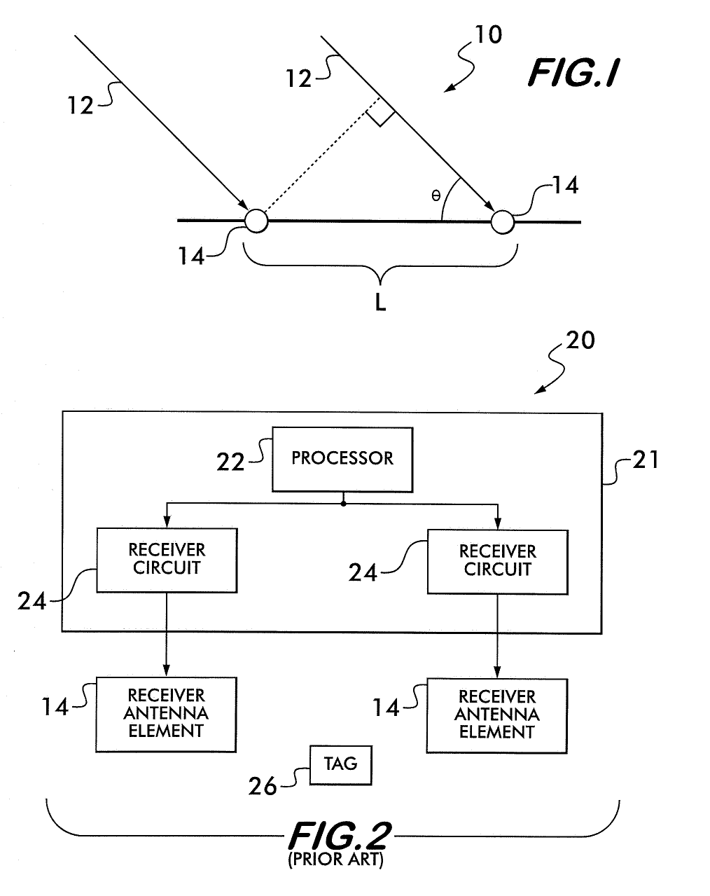

Referring now to FIG. 1, there is shown a schematic representation 10 of radio frequency waves 12 from an RFID source incident upon receiver antenna elements 14 of a receiver antenna array. The receiver antenna elements 14 are spaced a distance L apart from each other. The schematic representation 10 is useful for illustrating a system and method for determining angle of arrival (AOA) information in RFID communications systems. Angle of arrival measurement is a method for determining the direction of propagation of radio frequency waves, such as the radio frequency waves 12, incident upon the receiver antenna elements 14 of an RFID antenna array.

Furthermore, angle of arrival measurements obtained using the schematic representation 10 can be used to determine the direction of propagation of the radio frequency waves 12 by measuring the time difference of arrival (TDOA) at the individual receiver elements 14 of the antenna array. Based upon the delays indicated by the TDOA measured at the individual receiver antenna elements 14, the direction of propagation of the radio frequency waves 12 can be calculated. For narrowband systems, the TDOA measurement can be made by measuring the difference in the received phases at each of the receiver antenna elements 14 in a multiantenna array. With an antenna array consisting of the two receiver antenna elements 14 mounted along a line as shown in the schematic representation 10, it is possible to measure a single angle of arrival of the radio frequency waves 12.

Referring now to FIG. 2, there is shown a block diagram representation of a prior art angle of arrival measurement system 20. The angle of arrival measurement system 20 has an RFID reader 21 and two receiver antenna elements 14 for receiving the radio frequency waves 12 from an RFID source such as the RFID tag 26, as shown in the schematic representation 10. Therefore, the angle of arrival measurement system 20 can be used to estimate the angle of arrival of backscattered radio frequency signals 12 from a source of radio frequency signals, such as an RFID tag 26. Additionally, the angle of arrival measurement system 20 can approximately position the RFID tag 26 using the estimated angle of arrival information.

The RFID reader 21 of the angle of arrival system 20 includes two receiver circuits 24 and a processor 22. Each of the receiver circuits 24 is coupled to one of the receiver antenna elements 14, so that each receiver circuit 24 can process the signals received by one of the receiver antenna elements 14. The two receiver circuits 24 are also coupled to the processor 22. The processor 22 can perform the operations on the signals received from the RFD source by way of the receiver antenna elements 14 and the receiver circuits 24, as required for estimating the angle of arrival information and the position information of the RFID tag 26.

If the RFID tag 26 providing the backscatter signals to the angle of arrival measurement system 20 is far enough away from the receiver antenna elements 14, it can be assumed that the radio frequency waves 12 arrive at the antenna array as a plane wave. Under these circumstances the radio frequency signals 12 arrive substantially parallel to the receiver antenna array. This assumption is valid if the distance from the RFID tag 26 to the receiver antenna elements 14 is on the order of ten times larger than the distance L between the individual receiver antenna elements 14.

It is well known to those skilled in the art that the relationship between the angle of arrival, θ, of the radio frequency waves 12 at an antenna array, and the phase difference, φ, between the signals received by the receiver antenna elements 14 of the antenna array can be expressed by the following equations:

$$\begin{matrix}φ = \frac{cos ( θ ) L}{λ} 2 π & ( 1 ) \\ θ = {cos}^{- 1} ( \frac{φ \cdot λ}{2 π L} ) & ( 2 )\end{matrix}$$

where λ is the wavelength of the radio frequency waves 12.

Furthermore, there is a unique one to one relationship between the angle of arrival θ and the phase difference φ as long as the antenna spacing L is less than half the wavelength λ of the incident radio frequency waves 12. That is, there is a one to one relationship between the angle of arrival θ and the phase difference φ if L≦λ/2. Typically, if there is noise present in the system the angle of arrival estimate is more accurate when the antenna spacing is larger. Thus, a spacing of λ/2 between the receiver antenna elements 14 is typically chosen as the antenna spacing. With an antenna spacing of L=λ/2, the relationship between the angle of arrival θ of the radio frequency waves 12 and the phase difference φ at the receiver antenna elements 14 can be expressed by the following equations:

φ=cos(θ)·π (3)

$$θ = {cos}^{- 1} ( \frac{φ}{π} ) . \qquad ( 4 )$$

Thus, an estime of the angle of arrival and the location of the source of radio frequency waves 12 can be performed using this method. However, in this method a separate receiver circuit 24 is required for each receiver antenna element 14. Therefore, obtaining angle of arrival information in this manner is very expensive.

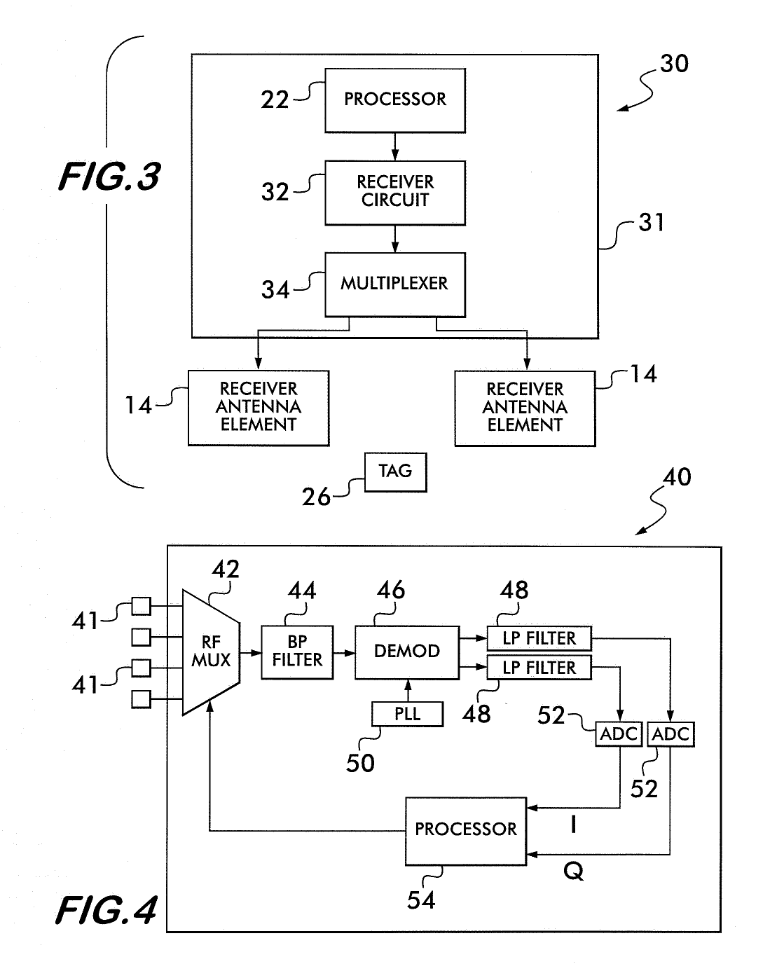

Referring now to FIG. 3, there is shown a block diagram representation of an embodiment of an angle of arrival measurement system 30 of the present invention. The angle of arrival measurement system 30 can be used to determine the angle of arrival of radio frequency signals, for example the radio frequency waves 12 from the RFID tag 26. Additionally, the angle of arrival measured by the measurement system 30 can be used for positioning the RFID tag 26. It will be understood that the angle of arrival measurement system 30 can be used for determining angle of arrival information and positioning information for any other type of device transmitting RF signals, for example other RFID readers.

The angle of arrival measurement system 30 includes an RFID reader 31 and two receiver antenna elements 14. Any type of reader circuitry known to those skilled in the art can be used in the RFID reader 31 of the angle of arrival measurement system 30. For example, the RFID reader 31 can be a conventional RFID reader for performing inventory rounds in a retail store having a large number of RFID tags fixed to assets in order to deter theft of the assets. In such inventory rounds tag populations can be queried for the contents of the memories of the tags. For example, the tags in the tag population can be queried for their Electronic Product Codes (EPC).

However, the RFID reader 31 within the angle of arrival system 30 can also include a single receiver circuit 32. Additionally, the RFID reader 31 can include a multiplexer 34 or other switching circuitry, which is coupled to the single receiver circuit 32. The multiplexer 34 is also coupled to the two receiver antenna elements 14. Therefore, the multiplexer 34 can alternately couple the signals received by each of the receiver antenna elements 14 to the single receiver circuit 32. Therefore, the signals received by the receiver antenna elements 14 can be alternately processed by the single receiver circuit 32, and applied to the processor 22 within the RFID reader 31, for positioning the RFID tag 26 or other source of radio frequency waves.

In alternate embodiments of the angle of arrival measurement system 30, any number of receiver antenna elements 14 can be multiplexed onto the single receiver circuit 32 by the multiplexer 34, for localizing the source of RFID signals using angle of arrival information obtained from the receiver antenna elements 14. Additionally, in other alternate embodiments (not shown) any number of multiplexers 32 or other switching circuits can be used to multiplex the receiver antenna elements 14 onto the single receiver circuit 32. Furthermore, in another alternate embodiment of the invention (not shown), a plurality of receiver antenna elements 14 can be multiplexed onto a receiver circuit 32 of a multi receiver circuit RFID reader.

Referring now to FIG. 4, there is shown a more detailed schematic representation of a possible embodiment of an RFID reader 40 of the present invention. The RFID reader 40 is suitable for use in the angle of arrival measurement system 30. The RFID reader 40 can have direct downconversion circuitry suitable for determining the angle of arrival information of radio frequency signals such as the radio frequency waves 12, from a source such as another RFID reader or the RFID tag 26. Additionally, the angle of arrival information measured by the angle of arrival measurement system 40 can be used by the RFID reader 40 for determining the position of the source of the radio frequency waves 12.

The RFD reader 40 can include a multiplexer 42 or other switching circuitry, which can be coupled to the reader input ports 41. The reader input ports 41 can be any type of antenna connections that can to be coupled to receiver antenna elements of an antenna array, such as the receiver antenna elements 14. In the embodiment of the RFID reader 40 four input ports 41 are shown for the purpose of illustration. However, it will be understood that the RFID reader 40 according to the invention can have any number of reader input ports 41 greater than two. The multiplexer 24 can multiplex the incoming backscatter signals received from the RFID tag 26, by way of the receiver antenna elements 14 and the reader input ports 41, onto the downconversion circuitry of the RFID reader 40 for processing.

The bandpass filter 44 within the RFID reader 40 receives the multiplexed antenna signal from the multiplexer 42. The filtering by the bandpass filter 44 can prevent unwanted out of band signals from jamming the circuitry of the RFID reader 40. After bandpass filtering, the signal is downconverted to baseband using a quadrature demodulator 46. The quadrature demodulator 46 mixes the incoming backscatter signal received from the bandpass filter 44 with an RF signal generated by a phase locked loop 50. The downconverted signal from the quadrature demodulator 46 can be centered at 0 Hz. Furthermore, the downconverted signal can be split into two component signals: an in phase component I and a quadrature component Q. The I and Q component signals are 90 degrees out of phase with each other.

By measuring the amplitude of the I and Q components, an absolute phase of the incoming backscatter signals received by the multiplexed receiver antenna elements 14 can be calculated. In a preferred embodiment the measurement can be made in the digital domain. Therefore, the I and Q components can be low pass filtered separately by the respective low pass filters 48. The low pass filtered I and Q signals can then be digitized by respective analog to digital converters 52. The resulting digitized I and Q signals from the analog to digital converters 52 can then be applied to a processor 54. The processor 54 can then compute the absolute phase of the input radio frequency waves 12. The absolute phase of a single input radio frequency wave 12 can be calculated as:

$$phase = {tan}^{- 1} ( \frac{Q}{I} ) \qquad ( 5 )$$

where I is the amplitude of the in phase component and Q is the amplitude of the quadrature component. However, as previously described, the angle of arrival measurements necessary for localizing a source of radio frequency waves require the determination of the relative phases between the signals received at the receiver antenna elements 14. The absolute phase of the signals does not provide enough information by itself.

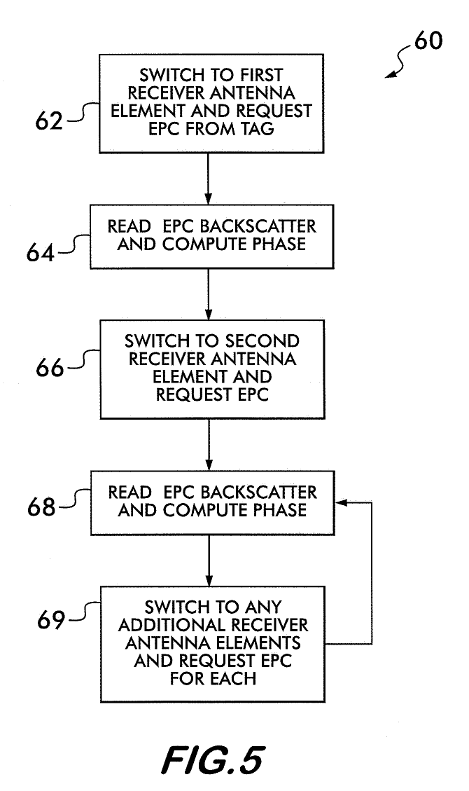

Referring now to FIG. 5, there is shown a flowchart representation of an RF source localizing method 60 for localizing sources of radio frequency signals in RFID communications systems using a single receive channel according to the invention. For example, the RF source localizing method 60 can be used by the processor 54 of the RFID reader 40 to localize a source of radio frequency waves 12 such as the RFID tag 26.

It is well known to those skilled in the art that RFID readers such as the RFID reader 40 can obtain a signal such as an EPC from an RFID tag 26 by transmitting a request signal to the RFID tag 26. The request signal from the RFID reader 40 causes the RFID tag 26 to transmit a backscatter response signal containing the EPC or other information associated with the RFID tag 26. Therefore, in this embodiment of the invention, a switching circuit such as the multiplexer 42 of the RFID reader 40 can switch to a first receiver antenna element 14, and request a backscatter signal such as an EPC signal from the RFID tag 26 as shown in block 62. The backscattered EPC response signal from the RFID tag 26 can be read by the RFID reader 40 using the first receiver antenna element 14 as shown in block 64. The processor 54 within the RFID reader 40 can compute the phase or delay information of the EPC backscatter signal received by the first receiver antenna element 14.

The multiplexer 42 in the RFID reader 40 can then switch a second receiver antenna element 14 onto the circuitry of the single receiver channel of the RFID reader 40, and again request the EPC or other information from the RFID tag 26, as shown in block 66. The multiplexer 42 can be any switching circuitry known to those in the art to selectively couple and uncouple whatever number of receiver antenna elements with the circuitry of the receiver channel of the RFID reader 40. The backscatter EPC signal transmitted in response to the request of block 66 is received by way of the second receiver antenna element 14 as shown in block 68. The processor 54 can then compute the phase or delay information of the received backscatter signal.

Using the phase information, or the delay information, calculated for the two receiver antenna elements 14 in blocks 64, 68, the processor 54 in the RFID reader 40 can calculate the angle of arrival information of the radio frequency signals 12 incident on the first and second receiver antenna elements 14. If there are any additional receiver antenna elements 14 coupled to the input ports 41 of the RFID reader 40, the RFID reader 40 can request the EPC from the RFID tag 26 again for each additional antenna element 14, as shown in block 69. The phase can also be computed for each additional EPC backscatter signal.

Thus, a backscatter signal such as an EPC response signal can be requested from the RFID tag 26 for each receiver antenna element 14 coupled to the RFID reader 40. Each time the RFID tag 26 receives a request signal, and backscatters in response to the request, the RFID reader 40 can read the backscatter response signal by way of one of the multiplexed receiver antenna elements 14 and its single receive channel. Each time a backscattered EPC response signal is received in this manner the processor 54 can compute the phase of the received signal. In this embodiment of the invention the number of EPC reads that are made by the RFID reader 40 for each RFID tag 26 can determine the tag throughput.

In one embodiment of the invention the multiplexer 42 can multiplex the receiver antenna elements 14, receiving the backscatter response signals from the RFID tag 26 over multiple backscatter packets, occurring over multiple inventory rounds. The received packets can contain a random number backscatter signal, such as a typical 16 bit random number (RN16) backscatter signal, an EPC backscatter signal, or backscatter signals including any other contents of the memory of the RFID tag 26. In one embodiment, the angle of arrival and localization computations can be performed by the RFID reader 40 over the multiple inventory rounds. For example, one read can be performed for each round. In another embodiment, the multiplexer 42 can multiplex several or all of the receiver antenna elements 14 receiving the backscatter signals from the RFID tag 26 during a single backscatter packet of a single inventory round. Accordingly, the angle of arrival can be computed over a few inventory rounds or during a single inventory round.

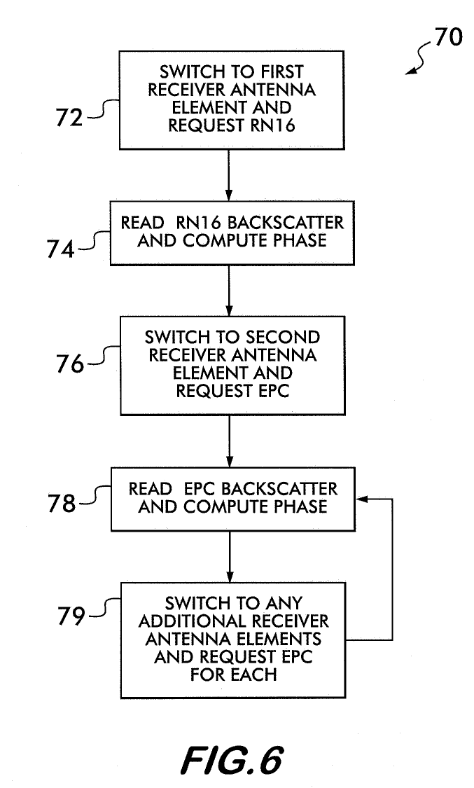

Referring now to FIG. 6, there is shown a flowchart representation of an RF source localizing method 70. The RF source localizing method 70 is an alternate embodiment of the invention for localizing sources of RF signals such as RFID readers or RFID tags in RFID communications systems. In the RF source localizing method 70 the multiplexer 42 in the RFID reader 40 can select a first receiver antenna element 14 as shown in block 72. However, in this embodiment of the invention, the RFID reader 40 can request a value other than an EPC from the RFID tag 26. For example, the reader can request an RN16 signal, as also shown in block 72. The RFID reader 40 can then receive the backscattered RN16 response signal from the RFID tag 26 by way of the first receiver antenna element 14, and compute the phase for the received signal as shown in block 74.

It will be understood by those skilled in the art that the RN16 signal which can be requested in block 72 represents a value commonly used in conventional RFID communications protocols, and is therefore commonly available to the RFID reader 40 as part of performing the conventional protocols. Thus, the RF source localizing method 70 can use a read of the RN16 signal that is performed as part of the protocols, to compute the phase information of the RFID tag 26 without performing any extra request or read operations. This can increase the throughput of the RF source localizing method 70.

The multiplexer 42 in the RFID reader 40 can then select a second receiver antenna element 14 as shown in block 76. The RFID reader 40 can then request another value from the tag 26. For example, the RFID reader 40 can request the EPC signal from the RFID tag 26, and the backscattered EPC response signal can be received from an RFID tag 26 by way of the second receiver antenna element 14. The phase can then be computed for the backscatter signal received by way of the second receiver antenna element 14, as shown in block 78. Since the EPC is required for many RFID communications protocols, the use of the EPC by the RF source localizing method 70 to compute the phase information can avoid overhead and increase throughput.

If there are any additional receiver antenna elements 14 coupled to the input ports 41 of the RFID reader 40, an additional EPC or other value can be requested, and the phase information can be computed for each response as shown in block 79. Based on the phase information, the angle of arrival information can be computed by the RF source localizing method 70 as described above.

As previously described, an RN16 backscatter signal and an EPC backscatter signal may already be required by conventional tag communication protocols when interrogating an RFID tag 26. For example both of these signals are required in the Gen 2 protocol. Thus, the angle of arrival information may be obtained using values that are available as part of performing the protocols. For example, in the case where the RFID reader 40 has only two receiver antenna elements 14, the RFID tag 26 can be interrogated once, and the necessary angle of arrival information can be computed for both receiver antenna elements 14. One angle of arrival can be computed for the RN16 backscatter and one for the EPC backscatter. However, in embodiments of the invention including more than two receiver antenna elements 14, the EPC or any other values transmitted by the source of radio frequency waves can be read additional times for the additional receiver antenna elements 14. The other values that are read can include, for example, hashed values, such as hashed EPC values, and access control values, such as access control values dependent on access privileges. The additional reads required for the additional antenna elements can add to the overhead required for performing the single receiver angle of arrival method, and may reduce the effective tag throughput.

While the invention has been described in detail and with reference to specific examples thereof, it will be apparent to one skilled in the art that various changes and modifications can be made therein without departing from the spirit and scope thereof.

1. A reader, comprising:
a single receiver circuit;
a switching circuit coupled to the single receiver circuit;
a first antenna connection coupled to the switching circuit, the first antenna connection configured to receive a first signal from a source of radio frequency waves;
a second antenna connection coupled to the switching circuit, the second antenna connection configured to receive a second signal from the source of radio frequency waves; and
a processor configured to determine angle of arrival information in accordance with the first and second signals.

2. The reader of claim 1, wherein the processor is further configured to determine relative phase information in accordance with the first and second signals.

3. The reader of claim 1, wherein the processor is further configured to localize the source of radio frequency waves in accordance with the angle of arrival information.

4. The reader of claim 1, wherein the switching circuit further comprises a multiplexer selectively coupling the first and second antenna connections to the single receiver circuit.

5. The reader of claim 1, wherein the first antenna connection is further configured to receive an electronic product code signal from a tag.

6. The reader of claim 5, wherein the second antenna connection is further configured to receive a further electronic product code signal.

7. The reader of claim 1, wherein the first antenna connection is further configured to receive a random number signal from a tag.

8. The reader of claim 7, wherein the second antenna connection is further configured to receive an electronic product code signal.

9. The reader of claim 1, wherein the reader comprises a further receiver circuit.

10. The reader of claim 1, wherein the first and second signals are received by the reader during a single packet transmission by the source of radio frequency waves.

11. The reader of claim 1, wherein the first and second signals are received by the reader during differing packet transmissions by the source of radio frequency waves.

12. The reader of claim 1, wherein the first signal is received in accordance with a tag communication protocol.

13. The reader of claim 12, wherein the second signal is received in accordance with a tag communication protocol.

14. A tag communication method in a reader having at least two antenna connections, comprising:
(a) coupling a first antenna connection to a single receiver circuit;
(b) receiving a first signal from a source of radio frequency waves by way of the first antenna connection and the single receiver circuit,
(c) coupling a second antenna connection to the single receiver circuit;
(d) receiving a second signal from the source of radio frequency waves by way of the second antenna connection and the single receiver circuit; and
(e) determining angle of arrival information in accordance with the first and second signals.

15. The tag communication method of claim 14, further comprising localizing the source of radio frequency waves in accordance with the angle of arrival information.

16. The tag communication method of claim 14, wherein the first signal further comprises an electronic product code signal from a tag.

17. The tag communication method of claim 14, further comprising selectively coupling the first and second antenna connections to the single receiver circuit using a switching circuit.

18. The tag communication method of claim 14, further comprising receiving the first and second signals during a single packet transmission by the source of radio frequency.

19. The tag communication method of claim 14, further comprising receiving the first and second signals during differing packet transmissions by the source of radio frequency.

20. The tag communication method of claim 14, further comprising receiving at least one of the first and second signals in accordance with a tag communication protocol.
